(19) United States
(12) Patent Application Publication
(10) Pub. No.: US 2025/0044612 A1
(43) Pub. Date: Feb. 6, 2025

(54) IMAGE DISPLAY DEVICE

(71) Applicant: InnoLux Corporation, Miao-Li County (TW)

(72) Inventors: En-Jie CHEN, Miao-Li County (TW); Yu-Shih TSOU, Miao-Li County (TW); Yu-Wei TU, Miao-Li County (TW); Chih-Lung LIN, Miao-Li County (TW)

(73) Assignee: InnoLux Corporation, Miao-Li County (TW)

(21) Appl. No.: 18/765,316

(22) Filed: Jul. 7, 2024

Related U.S. Application Data
(60) Provisional application No. 63/530,704, filed on Aug. 4, 2023.

(30) Foreign Application Priority Data
May 6, 2024 (CN) 202410544528.9

(51) Int. Cl. G02B 30/56; G02B 5/08

(52) U.S. Cl. CPC G02B 30/56; G02B 5/08

(57) ABSTRACT

Disclosed is an image display device including a display device, an optical modulation element, and a modulation device. When the modulation device is in a first state, the display device projects a first image at a first imaging position through the optical modulation element. When the modulation device is in a second state, the display device projects a second image at a second imaging position through the optical modulation element. A minimum distance from the first imaging position to the optical modulation element is different from a minimum distance from the second imaging position to the optical modulation element.

### CROSS REFERENCE TO RELATED APPLICATION

This application claims the benefit of U.S. Provisional Application No. 63/530,704, filed on Aug. 4, 2023. The content of the application is incorporated herein by reference.

### BACKGROUND OF THE DISCLOSURE

### 1. Field of the Disclosure

The present disclosure relates to an image display device and particularly to an image display device capable of projecting a floating three-dimensional image.

### 2. Description of the Prior Art

Traditional electronic devices for projecting images are to a project flat image onto a flat screen, such that a user can view the image on the screen. However, this design only can present the flat image but cannot show a three-dimensional image of an object or a three-dimensional image moving in three-dimensional space. Although two flat display devices have been developed to project two flat images at different distances from the user, these two projected images are separated, so that they cannot be combined or matched with each other to form a three-dimensional image.

### SUMMARY OF THE DISCLOSURE

One of objectives of the present disclosure is to provide an image display device to solve the above problems.

According to one embodiment of the present disclosure, an image display device is provided. The image display device includes a display device, an optical modulation element, and a modulation device. The display device has a display surface, wherein the display surface has a normal direction. The optical modulation element is disposed on the display device, wherein an angle is between the optical modulation element and the display surface of the display device, and the angle is greater than or equal to 20 degrees and less than or equal to 70 degrees. The modulation device overlaps the display device and the optical modulation element. When the modulation device is in a first state, the display device projects a first image at a first imaging position through the optical modulation element. When the modulation device is in a second state, the display device projects a second image at a second imaging position through the optical modulation element, and a minimum distance from the first imaging position to the optical modulation element is different from a minimum distance from the second imaging position to the optical modulation element.

According to another embodiment of the present disclosure, an image display device is provided. The image display device includes an optical modulation element, a first display device, and a second display device. The first display device has a display surface, and the first display device and the second display device are disposed on a same side of the optical modulation element. An angle is between the optical modulation element and the display surface of the first display device, and the angle is greater than or equal to 20 degrees and less than or equal to 70 degrees. The first display device projects a first image at a first imaging position through the optical modulation element, and the second display device projects a second image at a second imaging position through the optical modulation element. The minimum distance from the first imaging position to the optical modulation element is different from a minimum distance from the second imaging position to the optical modulation element.

In the image display device of the present disclosure, by the modulation device or two display devices, the images may be displayed at different imaging positions with different distances from the optical modulation element at different time points or at the same time point, so that different images may be combined to form the floating three-dimensional image, or they may interact with each other to show the movement of the floating image.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a side view of an image display device according to a first embodiment of the present disclosure.

FIG. 2 schematically illustrates a side view of an optical modulation element according to an embodiment of the present disclosure.

FIG. 3 schematically illustrates a side view of an optical modulation element according to another embodiment of the present disclosure.

FIG. 4 schematically illustrates a side view of a modulation device according to a variant embodiment of the first embodiment of the present disclosure.

FIG. 5 schematically illustrates a side view of an image display device according to a second embodiment of the present disclosure.

FIG. 6 and FIG. 7 schematically illustrate side views of the image display device displaying images at different imaging positions according to a variant embodiment of the second embodiment of the present disclosure.

FIG. 8 schematically illustrates a side view of an image display device according to a third embodiment of the present disclosure.

FIG. 9 schematically illustrates an image display device according to a first variant embodiment of the third embodiment of the present disclosure.

FIG. 10 schematically illustrates a side view of an image display device according to a second variant embodiment of the third embodiment of the present disclosure.

FIG. 11 schematically illustrates a side view and an operating method of an image display device according to a fourth embodiment of the present disclosure.

FIG. 12 schematically illustrates a side view of an image display device according to a variant embodiment of the fourth embodiment of the present disclosure.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and elements therein may not be drawn to scale. The numbers and sizes of the elements in the drawings are just illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not function.

In the following specification and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. It does not mean that the element has any previous ordinal numbers, nor does it represent the order of a certain element and another element, or the sequence in a manufacturing method. These ordinal numbers are just used to make a claimed element with a certain name be clearly distinguishable from another claimed element with the same name.

Spatially relative terms, such as “above”, “on”, “beneath”, “below”, “under”, “left”, “right”, “before”, “front”, “after”, “behind” and the like, used in the following embodiments just refer to the directions in the drawings and are not intended to limit the present disclosure.

In addition, when one element or layer is “on” or “above” another element or layer or is “connected to” the another element or layer, it may be understood that the element or layer is directly on the another element or layer or directly connected to the another element or layer, and alternatively, another element or layer may be between the element or layer and the another element or layer (indirectly). On the contrary, when the element or layer is “directly on” the another element or layer or is “directly connected to” the another element or layer, it may be understood that there is no intervening element or layer between the element or layer and the another element or layer.

The term “electrically connected” includes means of direct or indirect electrical connection. Two elements electrically connected to each other may be in direct contact with each other to transfer electrical signals, and there is no other element between them. Alternatively, two elements electrically connected to each other may be bridged through another element between them to transfer electrical signals. The term “electrically connected” may also be referred to as “coupled”.

As disclosed herein, the terms “approximately”, “essentially”, “about”, or “substantially” generally mean within 20%, 10%, 5%, 3%, 2%, 1%, or 0.5% of the reported numerical value or range.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

In the present disclosure, the length, thickness, width, height, distance, and area may be measured by using an optical microscope (OM), a scanning electron microscope (SEM) or other approaches, but not limited thereto.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a specific definition in the embodiments of the present disclosure.

An electronic device of the present disclosure may, for example, include a sensing device, a display device, an antenna device, a touch device, a tiled device or other suitable devices, but not limited thereto. The electronic device may, for example, be glasses, a window, or other suitable products. The sensing device may, for example, be a sensing device used for detecting change in capacitances, light, heat, or ultrasound, but not limited thereto. The sensing device may, for example, include a biosensor, a touch sensor, a fingerprint sensor, other suitable sensors or any combination of sensors mentioned above. The display device of the present disclosure may be any kind of display device, such as a self-luminous display device or a non-self-luminous display device. The self-luminous display device may include light emitting diodes, light conversion layers, other suitable materials or any combination of elements mentioned above. The light emitting diode may, for example, include an organic light emitting diode (OLED), a mini light emitting diode (mini LED), a micro light emitting diode (micro LED), a quantum dot light emitting diode (e.g., QLED or QDLED), but not limited thereto. The light conversion layer may include wavelength conversion materials and/or light filtering materials. The light conversion layer may, for example, include a fluorescent material, a phosphor material, quantum dot (QD), other suitable materials or any combination of elements mentioned above, but not limited thereto. The antenna device may, for example, include liquid crystal antenna or antennas of other types, but not limited thereto. The tiled device may, for example, include a tiled display device or a tiled antenna device, but not limited thereto. Furthermore, the appearance of the electronic device may be, for example, rectangular, circular, polygonal, a shape with curved edges, curved or other suitable shapes. The electronic device may have peripheral systems such as a driving system, a control system, a light source system, a shelf system, etc. The electronic device may include electronic units, in which the electronic units may include a passive element and an active element, and for example include a capacitor, a resistor, an inductor, a diode, a transistor, a sensor, etc. It is noted that the electronic device of the present disclosure may be any combination of the above-mentioned devices, but not limited thereto.

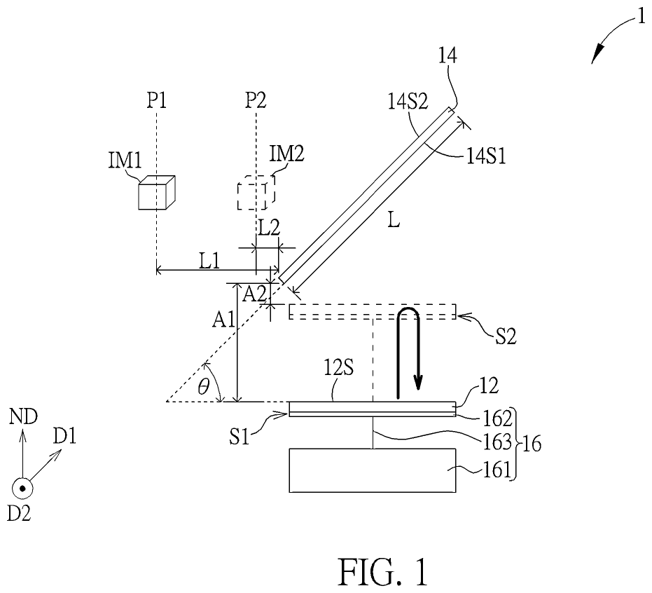

Refer to FIG. 1, which schematically illustrates a side view of an image display device according to a first embodiment of the present disclosure. As shown in FIG. 1, the image display device 1 provided in this embodiment includes a display device 12, an optical modulation element 14 and a modulation device 16, wherein the optical modulation element 14 is disposed on the display device 12. The display device 12 may have a display surface 12S, and the display surface 12S may have a normal direction ND. An angle θ is between the optical modulation element 14 and the display surface 12S of the display device 12, which is greater than or equal to 20 degrees and less than or equal to 70 degrees. In the normal direction ND of the display surface 12S, the modulation device 16 overlaps the display device 12 and the optical modulation element 14. When the modulation device 16 is in the first state S1, the display device 12 projects an image IM1 at the first imaging position P1 through the optical modulation element 14. When the modulation device 16 is in the second state S2, the display device 12 projects the image IM2 at the second imaging position P2 through the optical modulation element 14. Furthermore, a minimum distance L1 from the first imaging position P1 to the optical modulation element 14 is different from a minimum distance L2 from the second imaging position P2 to the optical modulation element 14. It should be noted that by changing the state of the modulation device 16, a distance between the display device 12 and the optical modulation element 14 may be altered to adjust a position where an image generated by the display device 12 is imaged through the optical modulation element 14. Accordingly, it may achieve the effect of moving images in the air and/or showing three-dimensional images with depth of field.

In detail, the optical modulation element 14 may be used to project the image generated by the display device 12 located on one side of the optical modulation element 14 to the other side of the optical modulation element 14, thereby displaying a floating image in the air. The optical modulation element 14 may be, for example, a retroreflector or other elements capable of generating retroreflection. In the embodiment of FIG. 1, an area of the optical modulation element 14 projected onto a plane parallel to the display surface 12S may be greater than an area of the display surface 12S, so that a whole of the image displayed on the display surface 12S may be imaged by the optical modulation element 14, but not limited thereto.

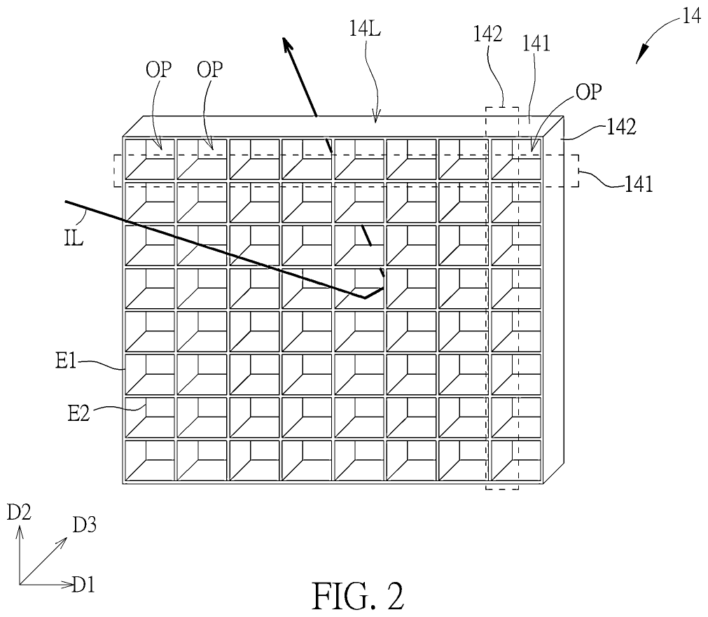

Refer to FIG. 2, which schematically illustrates a side view of an optical modulation element according to an embodiment of the present disclosure. As shown in FIG. 2, the optical modulation element 14 of an embodiment may have a plurality of openings OP, wherein sidewalls of each opening OP are mirror surfaces. The openings OP may be the same as each other, for example having the same shape, size and depth. The opening OP may be, for example, rectangular or other suitable shape. As an example, the openings OP may be arranged in an array, so that the optical modulation element 14 may have a grid-like structure, but not limited thereto. In other words, the optical modulation element 14 may include a plurality of first reflective walls 141 extending along a direction D1 and a plurality of second reflective walls 142 extending along another direction D2, and each first reflective wall 141 may pass through and intersects each second reflective wall 142, so that two adjacent first reflective walls 141 arranged in the direction D2 and two adjacent second reflective walls 141 arranged in the direction D1 may surround and form one of the openings OP. Surfaces of the first reflective wall 141 and the second reflective wall 142 facing the openings OP are mirror surfaces for reflecting light of the image. The first reflective walls 141 and the second reflective walls 142 may, for example, have the same depth in a depth direction of the opening OP (e.g., a direction D3). In one embodiment, a light incident surface 14S1 and a light exiting surface 1452 of the optical modulation element 14 shown in FIG. 1 may be, for example, virtual planes formed by edges E1 and edges E2 of the openings OP corresponding to two opposite sides of the optical modulation element 14, respectively. In addition, a width of one of the first reflective walls 141 in the direction D2 and a width of one of the second reflective walls 142 in the direction D1 may be less than a width of one of the openings OP. For example, the optical modulation element 14 may not be easily visible to a user when viewing the optical modulation element 14 along a direction D3. The direction D1 and the direction D2 in FIG. 1 may be, for example, the same as the direction D1 and the direction D2 in FIG. 2, respectively. In some embodiments, the direction D1 and the direction D2 in FIG. 1 or mentioned below may be interchanged with each other.

As shown in FIG. 2, when the light IL is emitted to one of the openings OP along a traveling direction that is not parallel to the direction D1, the direction D2, and the direction D3 from one side of the optical modulation element 14, the light IL may be specularly reflected by the optical modulation element 14 and be emitted out from the other side of the optical modulation element 14. When an angle between the light IL and the direction D3 is greater than or equal to 20 degrees and less than or equal to 70 degrees, the light IL may be sequentially reflected by one or two mirrors after entering the opening OP and then be emitted out from the other side of the optical modulation element 14, so that the image generated by the display device 12 located on one side of the optical modulation element 14 may be imaged on the other side of the optical modulation element 14 through the optical modulation element 14.

In other words, as shown in FIG. 1, when the angle θ between the optical modulation element 14 and the display surface 12S of the display device 12 is greater than or equal to 20 degrees and less than or equal to 70 degrees, the optical modulation element 14 may image or project the image displayed on the display surface 12S of the display device 12 to the air, which enable the user to view the floating image. Moreover, a distance between any point on the image displayed on the display surface 12S of the display device 12 and the optical modulation element 14 may be approximately the same as a distance between a corresponding point on the projected image (i.e., the imaging position of the corresponding point) and the optical modulation element 14. That is, a minimum distance L1 between the first imaging position P1 and the optical modulation element 14 may be the same as a minimum distance A1 between the display surface 12S and the optical modulation element 14 when the display device 12 is in the first state S1, and a minimum distance L2 between the second imaging position P2 and the optical modulation element 14 may be the same as the minimum distance A1 between the display surface 12S and the optical modulation element 14 when the display device 12 is in the second state S2. The difference between the minimum distance L1 and the minimum distance L2 may be, for example, the same as the difference between the minimum distance A1 and the minimum distance A2.

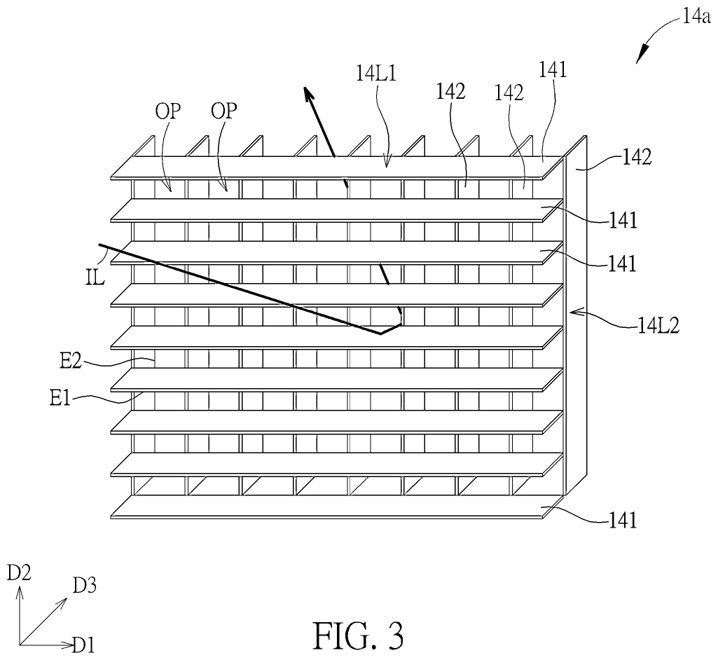

In FIG. 2, the optical modulation element 14 may be a single-layer structure, which means the first reflective walls 141 and the second reflective walls 142 may be formed of the same reflective layer 14L, but it is not limited thereto. Refer to FIG. 3, which schematically illustrates a side view of an optical modulation element according to another embodiment of the present disclosure. As shown in FIG. 3, the optical modulation element 14a provided by another embodiment may include a first reflective layer 14L1 and a second reflective layer 14L2 sequentially arranged along the direction D3, wherein the first reflective layer 14L1 may include a plurality of first reflective walls 141 extending along the direction D1, and the second reflective layer 14L2 may include a plurality of second reflective walls 142 extending along the direction D2, wherein the first reflective walls 141 are arranged in the direction D2, and the second reflective walls 142 are arranged in the direction D1. Two side surfaces of the first reflective wall 141 arranged in the direction D2 are mirror surfaces, and the two side surfaces of the second reflective wall 142 arranged in the direction D1 are also mirror surfaces, so that the light IL may be reflected by the mirror surfaces when it meets the above side surfaces. Viewed along the direction D3 in which the first reflective layer 141 and the second reflective layer 142 are sequentially stacked, the first reflective walls 141 and the second reflective walls 142 may form a plurality of openings OP. In an embodiment, a virtual plane is formed by the edges E1 of the first reflective walls 141 away from the second reflective walls 142 and a virtual plane formed by the edges E2 of the second reflective walls 142 away from the first reflective walls 141 shown in FIG. 3 may be, for example, the incident surface 14S1 and the light exiting surface 14S2 of the optical modulation element 14 shown in FIG. 1, respectively.

In the embodiment of FIG. 1, the display device 12 may be, for example, a flat display device for displaying two-dimensional images. The modulation device 16 may be used to move the display device 12, such that the display device 12 may move along the normal direction ND. Since the two-dimensional images displayed by the display device 12 at different times may be displayed at different positions with different distances from the optical modulation element 14 through the movement of the modulation device 16, the two-dimensional images at different positions may form three-dimensional and floating static or dynamic images through the imaging of the optical modulation element 14.

The modulation device 16 may for example include a moving device 161 used to move the display device 12 in the normal direction ND. In the embodiment of FIG. 1, the display device 12 may be disposed between the optical modulation element 14 and the modulation device 16. For example, the modulation device 16 may further include a carrier 162 and a supporting element 163, wherein the supporting element 163 is connected between the moving device 161 and the carrier 163, so that the moving device 161 may lift or lower the carrier 162 through the supporting element 163 to achieve an effect of moving the display device 12 up and down.

In one embodiment, the moving device 161 may include a distance moving element and/or a high frequency moving element. The distance moving element may include, for example, a motor, a hydraulic system, a gas pressure system, or other suitable elements, wherein the hydraulic system may include, for example, an oil pressure system or other suitable systems. When the moving device 161 includes the distance moving element, the display device 12 may move at a frequency of less than 1 Hz, and a range of movement may be, for example, from a few centimeters (cm) to a few meters (m), but not limited thereto. The frequency at which the distance moving element moves the display device 12 may be, for example, a ratio of a moving speed of the display device 12 to a moving distance that the display device 12 needs to move from the first state S1 to the second state S2 and back to the first state S1 from the second state S2. By using the distance moving element, the image display device 1 may display a movement of the floating image, for example, displaying the image IM1 moving from the first imaging position P1 to the second imaging position P2 to become the image IM2, wherein the image IM1 may be the same as the image IM2, or the image IM1 may be changed during the movement, such that the image IM2 may different from the image IM1, but not limited thereto. In some embodiments, the number of imaging positions may not be limited to two but may be more than two, so that the floating image may show continuous movement or stay at plural imaging positions at different time points.

Additionally, the high frequency moving element may include, for example, an elastic material, a piezoelectric material, or other suitable materials. When the moving device 161 includes a high frequency moving element, a moving frequency of the display device 12 may be greater than 60 Hz. Through the phenomenon of persistence of vision of the human eye, the human eye may see a three-dimensional image with thickness in a three-dimensional space. For example, the user may view the three-dimensional image IM1 at the first imaging position P1 or view the three-dimensional image IM2 at the second imaging position P2. The elastic material may, for example, include a spring or other suitable elements. When the moving device 161 includes the elastic material or the piezoelectric material, the moving range of the display device 12 may be, for example, several millimeters (mm) to several centimeters, but not limited thereto. In some embodiments, the moving device 161 may include both the high frequency moving element and the distance moving element, so that the user may not only view the three-dimensional image of the floating object, but also see the movement of the three-dimensional object. In some embodiments, the high frequency moving element may be optionally disposed at the carrier 162, for example under or on the carrier 162. In this content, “imaging position” may, for example, refer to a two-dimensional plane or a three-dimensional region having depth in the traveling direction of the projected light.

As shown in FIG. 1, in order to make the image have an obvious floating effect at the imaging positions (e.g., the first imaging position P1 and/or the second imaging position P2), in the normal direction ND, the minimum distance A1 from the display device 12 to the optical modulation element 14 may be greater than or equal to 10 cm, and in order to have good imaging quality, the minimum distance A1 may be less than or equal to

$$\frac{1}{2} ( \frac{log \frac{300}{η \times B}}{log α} \times 100 - \frac{L}{\sqrt{2}} ) cm ,$$

where η is an optical efficiency of the optical modulation element 14, Bis a center brightness of the display device 12, α is an optical distance maintenance rate of the display device 12, and L is a length of the optical modulation element 14. In FIG. 1, the length L of the optical modulation element 14 may refer to a length of the optical modulation element 14 in the direction D1. The minimum distance A1 from the display device 12 to the optical modulation element 14 may refer to a distance range within which the display device 12 may is able to move in the normal direction ND. Within this range, the modulation device 16 may have enough space to move and provide good floating 3D images. The center brightness B of the display device 12, the optical distance maintenance rate α of a light source of the display device 12, and the optical efficiency η of the optical modulation element 14 may be measured by any brightness measuring equipment in appropriate methods. For example, in the measurement of the optical distance maintenance rate α of the light source of the display device 12, a light intensity of the display device 12 may be measured by a brightness measuring device (e.g., a display measuring system (DMS) device) to obtain a measured value I0 of the light intensity at a position that is distanced from the display surface 12S of the display device 12 by 0 centimeters (cm) and obtain another measured value I100 of the light intensity at another position that is distanced from the display surface 12S of the display device 12 by 100 cm, and the optical distance maintenance rate α may be a ratio of the measured value I100 to the measured value I0 (i.e., I100/I0). The measuring method of the present disclosure is not limited thereto. In the measurement the optical efficiency η, an intensity of outgoing light exiting from the light exiting surface 14S2 and an intensity of incident light emitted to the light incident surface 14S1 of the optical modulation element 14 may be measured for example by a brightness measuring equipment, and the optical efficiency η of the optical modulation element 14 may be a ratio of the intensity of the outgoing light to the intensity of the incident light, but not limited thereto.

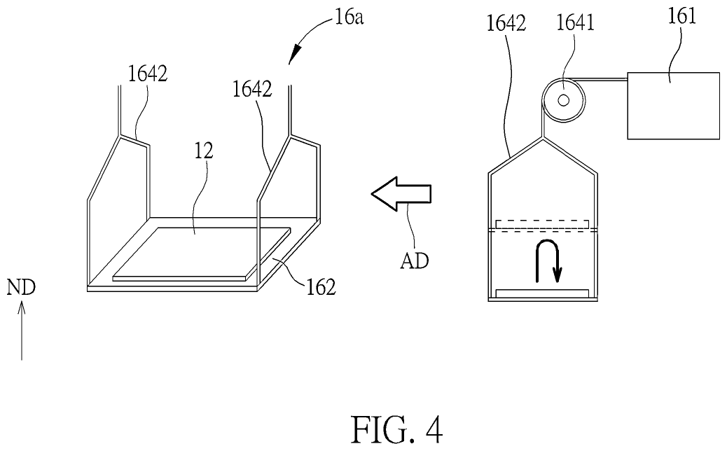

Refer to FIG. 4, which schematically illustrates a side view of a modulation device according to a variant embodiment of the first embodiment of the present disclosure, wherein a right part of FIG. 4 schematically a side view of a left part of FIG. 4 viewed along an arrow direction AD. As shown in FIG. 4, the modulation device 16a of this variant embodiment differs from the modulation device 16 of FIG. 1 in that the modulation device 16a of this variant embodiment may include a moving device 161, a carrier 162, and at least one transmission element 164. For example, the transmission element 164 may include a pulley 1641 and a transmission rope 1642, wherein the transmission rope 1642 is connected to the carrier 162, so that the moving device 161 may move the carrier 162 through the transmission rope 1642 to achieve an effect of moving the display device 12. In this variant embodiment, the transmission rope 1642 is connected to an edge of the carrier 162 to avoid an optical path of an image from the display device 12 to the optical modulation element being affected. In this variant embodiment, the moving device 161 may include, for example, a motor or other suitable elements.

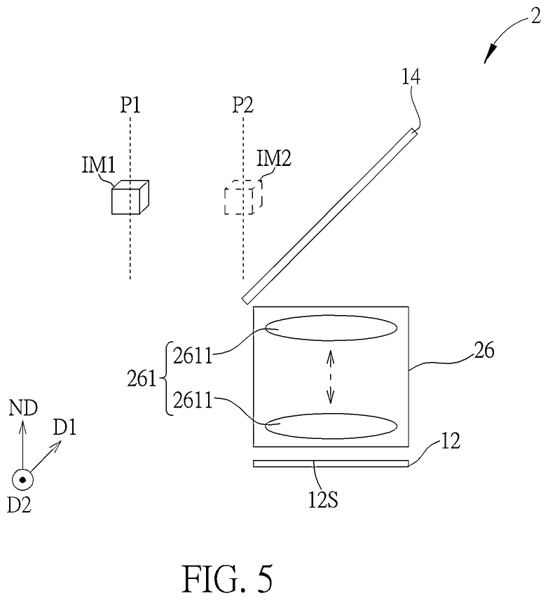

Refer to FIG. 5, which schematically illustrates a side view of an image display device according to a second embodiment of the present disclosure. As shown in FIG. 5, in the image display device 2 provided in this embodiment, the modulation device 26 may include a lens module 261 disposed between the display device 12 and the optical modulation element 14. In this case, the modulation device 26 may not include the moving device 161 and the supporting element 163 of FIG. 1, but not limited thereto. The lens module 261 may, for example, include a plurality of lenses 2611 and a mechanism device (not shown), wherein the mechanism device may be used to move the lenses 2611 in relation to each other at different time points to change a focal length of the lens module 261. For example, the lenses 2611 may be moved in the normal direction ND to change a distance between the lenses 2611. In other words, the modulation device 26 may be, for example, a mechanically tunable focus lens module. It should be noted that by changing the focal length of the lens module 261, the imaging position of the image displayed by the display device 12 and imaged through the lens module 261 may be adjusted at different time points, so that the image display device 2 may project the image IM1 to the first imaging position P1 at a time point and project the image IM2 to the second imaging position P2 at another time point, thereby achieving the effect of moving the image or displaying the three-dimensional image. In some embodiments, the image display device 2 of FIG. 5 may optionally further include the modulation device 26 of FIG. 1 to simultaneously combine the movement of the two-dimensional image with the change of the imaging position. Other parts of the image display device 2 of FIG. 5 may be the same as or similar to the image display device 1 of FIG. 1, and therefore, they may refer to the mentioned above and will not be repeated herein.

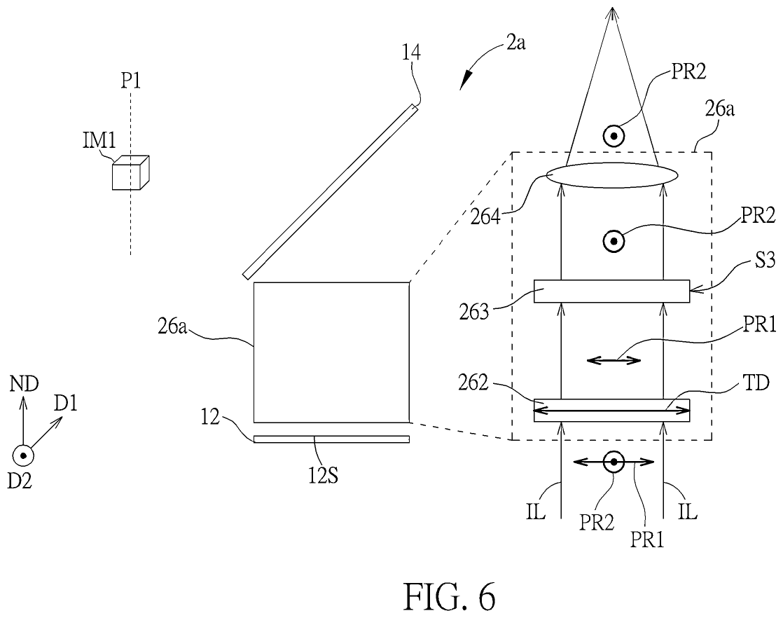

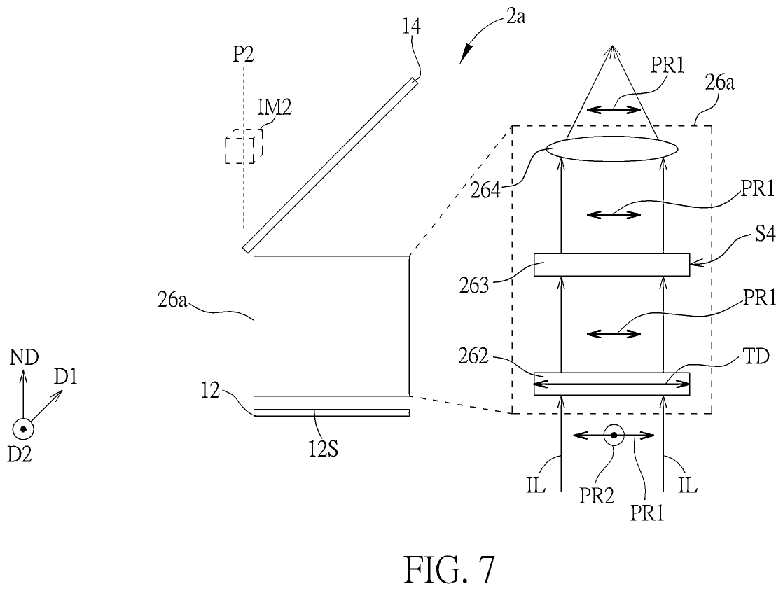

Refer to FIG. 6 and FIG. 7. FIG. 6 and FIG. 7 schematically illustrate side views of the image display device displaying images at different imaging positions according to a variant embodiment of the second embodiment of the present disclosure. As shown in FIG. 6 and FIG. 7, the image display device 2a of this embodiment differs from the image display device 2 of FIG. 5 in that the modulation device 26a of this embodiment may be replaced with a electrically tunable focus lens module. In other words, the modulation device 26a may adjust its focal length by an electric signal to have a change frequency of the focal length of more than 60 Hz, such that the image IM1 may present a three-dimensional object.

In this embodiment, the modulation device 26a may include, for example, a polarizer 262, a liquid crystal panel 263, and a birefringent lens 264 sequentially arranged along the normal direction ND on the display surface 12S of the display panel 12, wherein the liquid crystal panel 263 is disposed between the birefringent lens 264 and the polarizer 262 and used to adjust a polarization direction of light IL passing through them. The liquid crystal panel 263 may be, for example, a twisted nematic type liquid crystal panel or other suitable elements for controlling the polarization direction of the light IL passing through the liquid crystal panel 263. For example, when the display device 12 displays an image, the light IL of the image may have random polarization directions and therefore may be represented by a linear polarization direction PR1 and a linear polarization direction PR2 perpendicular to each other. After the light IL passes through the polarizer 262, the light IL may have the same linear polarization direction as the transmission direction TD of the polarizer 262, such as the linear polarization direction PR1. As shown in FIG. 6, when the liquid crystal panel 263 is in an on state S3, the polarization direction of the light IL will be changed to another linear polarization direction, such as the linear polarization direction PR2, after passing through the liquid crystal panel 263. As shown in FIG. 7, when the liquid crystal panel 263 is in an off state S4, the light IL having the linear polarization direction PR1 is not changed after passing through the liquid crystal panel 263. Since the birefringent lens 264 may have different focal lengths for light IL with different linear polarization directions, the liquid crystal panel 263 changing the polarization direction of the image light IL may adjust the focal length of the modulation device 26a, such that the image may be imaged on different imaging positions. For example, as shown in FIG. 6, when the focal length of the modulation device 26a becomes longer, the optical modulation element 14 may project the image from the display device 12 to the first imaging position P1 to form the image IM1. As shown in FIG. 7, when the focal length of the modulation device 26a becomes shorter, the optical modulation element 14 may project the image from the display device 12 to the second imaging position P2 to form the image IM2.

The relationship of the on state S3 and the off state S4 respectively corresponding to longer focal length and shorter focal length in the present disclosure is not limited to the mentioned above. In some embodiments, when the liquid crystal panel 263 is in the on state S3, the focal length of the modulation device 26a may be shorter, and when the liquid crystal panel 263 is in the off state S4, the focal length of the modulation device 26a may be longer. It should be noted that since the switching frequency of the liquid crystal panel 263 may be greater than 60 Hz, such as 120 Hz, the image display device 2a may form an image of the three-dimensional object through persistence of vision. In some embodiments, the linear polarization direction PR1 and the linear polarization direction PR2 in FIG. 6 and FIG. 7 may be interchanged. In some embodiments, the modulation device 26a may also be a liquid crystal lens or other suitable electrically tunable focus device, but not limited thereto. In some embodiments, the image display device 2a of FIG. 6 and FIG. 7 may optionally include the modulation device 16 of FIG. 1 or the modulation device 16a of FIG. 4 to simultaneously match the movement of the two-dimensional image with the change of the imaging position. Other parts of the image display device 2a in FIG. 6 and FIG. 7 may be the same as or similar to the image display device 1 in FIG. 1, so they may refer to the mentioned above and will not be described again herein.

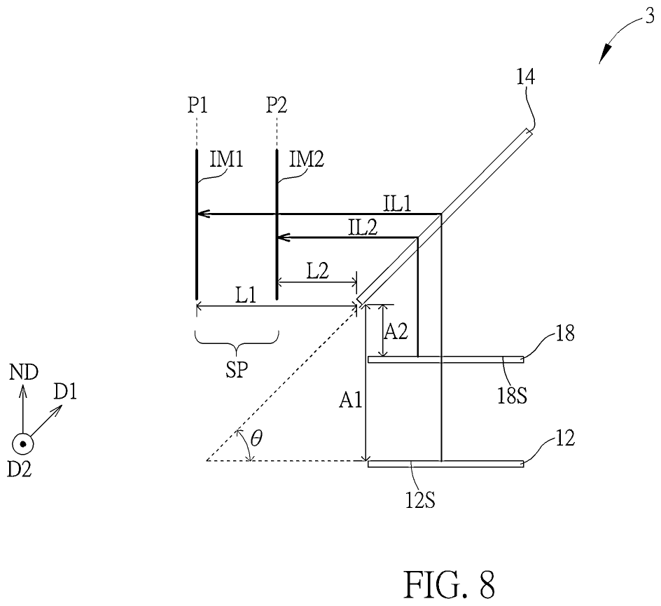

Refer to FIG. 8, which schematically illustrates a side view of an image display device according to a third embodiment of the present disclosure. As shown in FIG. 8, in the image display device 3 provided by this embodiment, the image display device 3 may include the optical modulation element 14, the display device 12 and another display device 18. The display device 12 and the display device 18 are arranged on the same side of the optical modulation element 14, wherein the display device 12 projects a first image IM1 at the first imaging position P1 through the optical modulation element 14, and the display device 18 projects the second image IM2 at the second imaging position P2 through the optical modulation element 14. Moreover, the minimum distance L1 from the first imaging position P1 to the optical modulation element 14 may be different from the minimum distance L2 from the second imaging position P2 to the optical modulation element 14. Similarly to the above embodiment, an angle θ may be between the optical modulation element 14 and the display surface 12S of the display device 12, and the angle θ is greater than or equal to 20 degrees and less than or equal to 70 degrees.

In the embodiment of FIG. 8, the display device 18 may be a transparent display device, and the display device 18 may overlap the display device 12 and the optical modulation element 14 in the normal direction ND of the display surface 12S, such that the light IL1 of the image displayed by the display device 12 may penetrate through the display device 18 and be imaged at the first imaging position P1 by the optical modulation element 14 while the display device 18 is displaying an image, and the light IL2 of the image displayed by the display device 18 may be imaged by the optical modulation element 14 at the second imaging position P2. The display surface 18S of the display device 18 may be, for example, parallel to the display surface 12S of the display device 12 to facilitate combination of the image displayed by the display device 12 with the image displayed by the display device 18. It should be noted that the minimum distance L1 between the first imaging position P1 and the optical modulation element 14 may be the same as the minimum distance A1 between the display surface 12S of the display device 12 and the optical modulation element 14, and the minimum distance L2 between the second imaging position P2 and the optical modulation element 14 may be the same as the minimum distance A2 between the display surface 18S of the display device 18 and the optical modulation element 14. Since the display device 12 and the display device 18 may respectively project the first image IM1 and the second image IM2 at different first imaging position P1 and second imaging position P2 by the optical modulation element 14 at the same time, the projected first image IM1 and the projected second image IM2 may be combined with each other to form a three-dimensional image in a three-dimensional space SP. Alternatively, the display device 12 and the display device 18 may generate the first image IM1 and the second image IM2 at different time points, so that the first image IM1 and the second image IM2 may present a movement of an object in the three-dimensional space SP.

In some embodiments, the image display device 3 of FIG. 8 may optionally further include the modulation device 16 of FIG. 1 and/or the modulation device 16a of FIG. 4, such that at least one of the display device 12 and the display device 18 may move up and down in the normal direction ND by the modulation device. Accordingly, the three-dimensional image and/or the movement of the three-dimensional image may be shown. Other parts of the image display device 3 of FIG. 8 may be the same as or similar to the image display device 1 of FIG. 1, so they may refer to the mentioned above and will not be described again here.

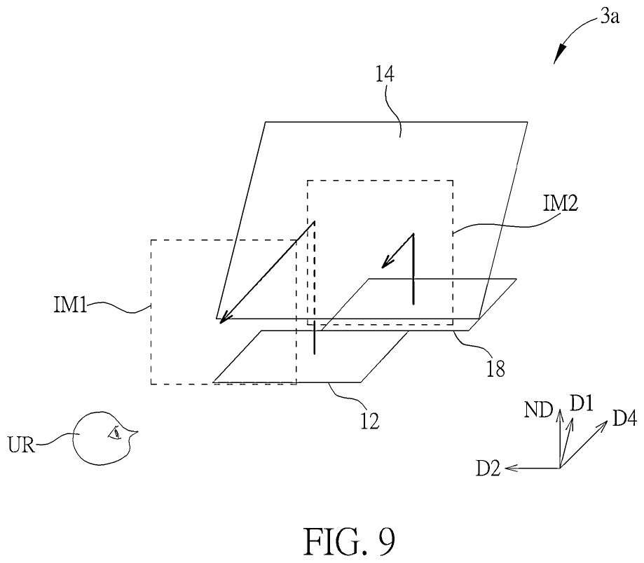

Refer to FIG. 9, which schematically illustrates an image display device according to a first variant embodiment of the third embodiment of the present disclosure. As shown in FIG. 9, the image display device 3a provided in this variant embodiment differs from the image display device 3 shown in FIG. 8 in that the display device 12 may partially overlap the display device 18 in the normal direction ND. For example, the display device 18 may be shifted in the second direction D2 parallel to the display surface 12S to be misaligned with the display device 12. In some embodiments, the display device 18 may be shifted in another direction D4 parallel to the display surface 12S and perpendicular to the direction D2 to be misaligned with the display device 12. Through the partial overlap of the display device 12 and the display device 18, the projected first image IM1 and the projected second image IM2 may partially overlap to facilitate combination of the first image IM1 with the second image IM2, such that the user UR may view the image with depth of field.

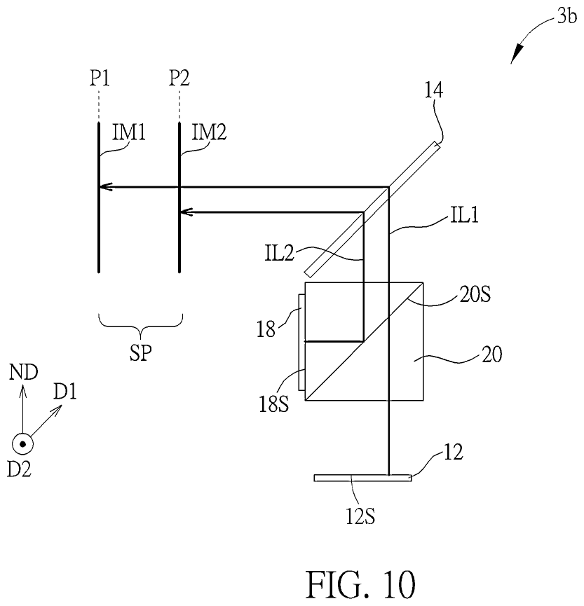

Refer to FIG. 10, which schematically illustrates a side view of an image display device according to a second variant embodiment of the third embodiment of the present disclosure. As shown in FIG. 10, the image display device 3b provided by this variant embodiment differs from the image display device 3 shown in FIG. 8 in that the image display device 3b further includes a beam splitting element 20 disposed between the display device 12 and the optical modulation element 14. In this embodiment, the display device 12 and the display device 18 may be disposed on two sides of the beam splitting element 20. Specifically, the beam splitting element 20 may have, for example, a transflective surface 20S, and the light IL1 of the image displayed by the display device 12 may pass through the transflective surface 20S to be projected to the first imaging position P1 by the optical modulation element 14 to form the first image IM1. Moreover, the display device 18 is disposed on a side of the beam splitting element 20, and the display device 18 and the optical modulation element 14 may be disposed on the same side of the transflective surface 20S, so that the light IL2 of the image displayed by the display device 18 may be reflected to the optical modulation element 14 by the transflective surface 20S to be projected at the second imaging position P2 by the optical modulation element 14 to form the second image IM2.

In some embodiments, the image display device 3b of FIG. 10 may optionally further include the modulation device 16 of FIG. 1 and/or the modulation device 16a of FIG. 4, such that at least one of the display device 12 and the display device 18 is capable of moving up and down in the normal direction ND (or in a normal direction of the display surface 18S of the display device 18) by the modulation device to show the three-dimensional image and/or the movement of the three-dimensional image. The position of the first image IM1 may be changed by adjusting the distance between the display device 12 and the beam splitting element 20. Similarly, the position of the second image IM2 may be changed by adjusting the distance between the display device 18 and the beam splitting element 20. Moreover, since the positions and movements of the display device 12 and the display device 18 do not affect each other, the first image IM1 and the second image IM2 may be limited to each other, such that they may overlap each other, or the minimum distance between the first image IM1 and the optical modulation element 14 may be greater or less than the minimum distance between the second image IM2 and the optical modulation element 14. Other parts of the image display device 3b of FIG. 10 may be the same as or similar to the image display device 1 of FIG. 1, so they may refer to the mentioned above and will not be repeated herein.

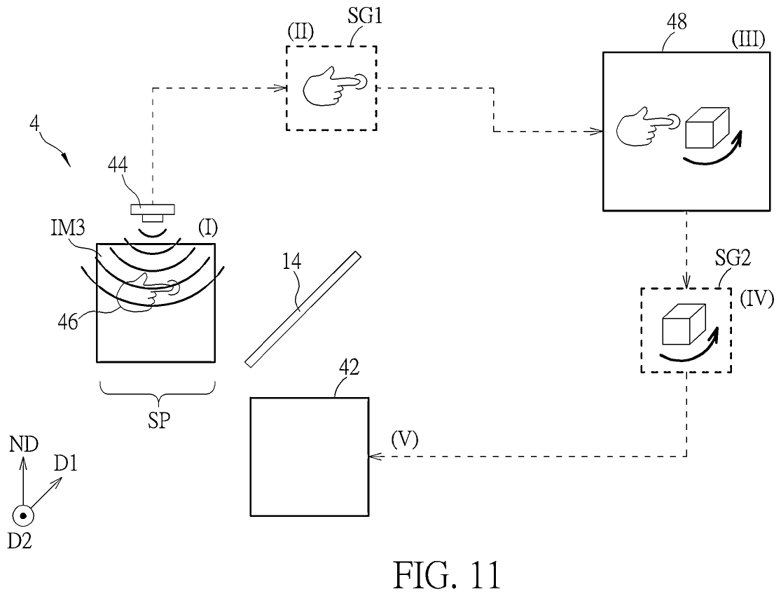

Refer to FIG. 11, which schematically illustrates a side view and an operating method of an image display device according to a fourth embodiment of the present disclosure. As shown in FIG. 11, the image display device 4 provided by this embodiment differs from the image display device 1 of FIG. 1 in that the display device 42 may be a three-dimensional image display device for displaying three-dimensional images. For example, the display device 42 may include a light field display, a fan display, or other suitable three-dimensional image display or projection device. Since the display device 42 may directly display the three-dimensional image, the three-dimensional image may be projected to the three-dimensional space SP through the optical modulation element 14 to form the corresponding three-dimensional image IM3.

In this embodiment, the image display device 4 may optionally further include an image sensing device 44 for detecting an action 46 of the user, such as a gesture or other suitable actions. By detecting the action 46 through the image sensing device 44, the user may interact with the three-dimensional image displayed by the display device 42 through the action 46. The image sensing device 44 may include, for example, an infrared image sensor, a camera, or other suitable image capturing devices. It should be noted that since at least part of the three-dimensional image displayed by the display device 42 is located in the display device 42, the user cannot actually interact with the part. Projecting the corresponding three-dimensional image IM3 to the air through the optical modulation element 14 may help the user to interact with the three-dimensional image IM3.

The operating method of the image display device 4 interacting with the action 46 of the user is further described below. As shown in FIG. 11, in step I, when the user performs the action 46 on the three-dimensional image IM3 in the three-dimensional space SP, the image display device 4 may detect the action 46 through the image sensing device 44. The action 46 may be, for example, using a finger to rotate the object in the three-dimensional image IM3 or performing other suitable gestures or actions. In step II, the image sensing device 44 transmits a detected signal SG1 of the action 46 to a computing device 48, such as a computer or other suitable devices. Then, in step III, the computing device 48 analyzes the action 46 and determines that the user performs the action 46 on the three-dimensional image IM3. Next, in step IV, the computing device 48 generates a signal SG2 of another three-dimensional image after the three-dimensional image IM3 undergoes the action 46 and transmits the signal SG2 to the display device 42. In step V, the display device 42 displays the another three-dimensional image of the three-dimensional image IM3 after performing the action 46 according to the signal SG2. Accordingly, the user may view the interacted three-dimensional image, thereby achieving the interaction between the image display device 4 and the user. In some embodiments, the display device 42 of FIG. 11 may be replaced by the image display device of any of the above embodiments. In other embodiments, the image display device 4 may further include a touch device disposed between the user and the three-dimensional image IM3, so that the user may interact with the three-dimensional image IM3 by touching the touch device, but the present disclosure is not limited thereto.

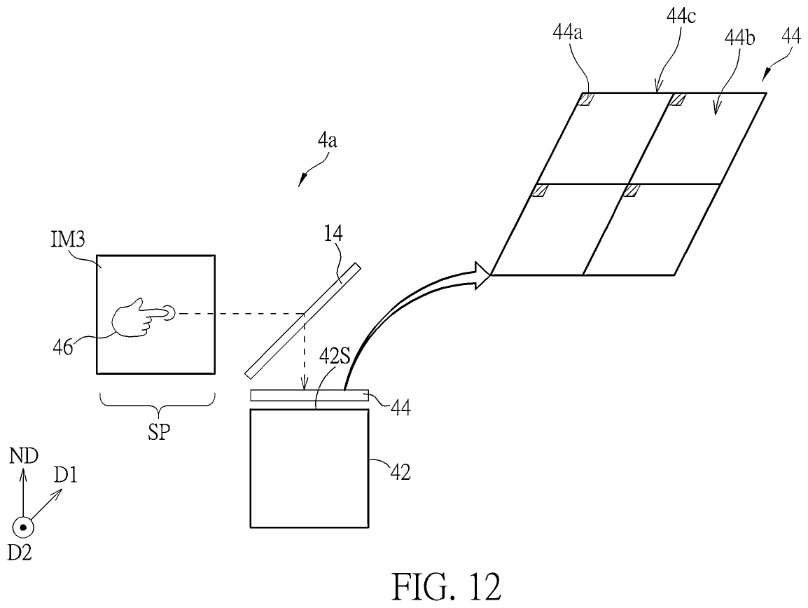

Refer to FIG. 12, which schematically illustrates a side view of an image display device according to a variant embodiment of the fourth embodiment of the present disclosure. As shown in FIG. 12, the image display device 4a provided in this embodiment differs from the image display device 4 of FIG. 11 in that the image sensing device 44 may include a transparent image sensing array disposed between the display device 42 and the optical modulation element 14. In this embodiment, the image sensing device 44 may be disposed on the display surface 42S of the display device 42 but is not limited thereto. In some embodiments, the image sensing device 44 may be integrated into the display device 42. A right part of FIG. 12 further shows an enlarged schematic view of the image sensing device 44 but is not limited thereto. As shown in the right part of FIG. 12, the image sensing device 44 may include a plurality of sensing elements 44a for detecting an image of the action 46 in the three-dimensional space SP by the optical modulation element 14. The sensing elements 44a may be arranged, for example, in an array or other suitable methods. The sensing elements 44a may, for example, include infrared sensors or other suitable sensors.

In this embodiment, the image sensing device 44 may further have a plurality of transparent regions 44b and a wire region 44c, wherein the transparent regions 44b may allow light to pass through, such that the three-dimensional image displayed by the display device 42 may penetrate through the transparent regions 44b to be projected in the three-dimensional space SP by the optical modulation element 14. The wire region 44c may surround the transparent regions 44b. The image sensing device may include a plurality of wires disposed in the wire region 44c and used for electrically connecting the sensing elements 44a, but not limited thereto. In FIG. 12, the sensing elements 44a may be respectively disposed at corners of the corresponding transparent regions 44b but are not limited thereto.

In some embodiments, the display device 42 of FIG. 12 may be replaced by the image display device of any of the above embodiments. When the image sensing device 44 of FIG. 12 is applied to an image display device with a modulation device (e.g., the image display device 1 shown in FIG. 1 or FIG. 4), the image sensing device 44 may be disposed on the display surface 12S of the display device 12, so that the image sensing device 44 may be moved with the movement of the display device 12. Accordingly, the image sensing device 44 may detect images of the action 46 of the user corresponding to different imaging positions to form a complete three-dimensional image of the action 46.

In summary, in the image display device of the present disclosure, by the modulation device or two display devices combined with the beam splitting element or the transparent display device, the images may be displayed at different imaging positions with different distances from the optical modulation element at different time points or at the same time point, so that different images may be combined to form the floating three-dimensional image, or they may interact with each other to show the movement of the floating image. In addition, since the image display device may form the floating three-dimensional image, an effect of human-computer interaction between the three-dimensional image and the user may be achieved through the image sensing device.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An image display device, comprising:
a display device having a display surface, wherein the display surface has a normal direction;
an optical modulation element disposed on the display device, wherein an angle is between the optical modulation element and the display surface of the display device, and the angle is greater than or equal to 20 degrees and less than or equal to 70 degrees; and
a modulation device overlapping the display device and the optical modulation element, wherein when the modulation device is in a first state, the display device projects a first image at a first imaging position through the optical modulation element,
when the modulation device is in a second state, the display device projects a second image at a second imaging position through the optical modulation element, and a minimum distance from the first imaging position to the optical modulation element is different from a minimum distance from the second imaging position to the optical modulation element.

2. The image display device as claimed in claim 1, wherein the modulation device comprises a moving device, and the display device is disposed between the optical modulation element and the modulation device.

3. The image display device as claimed in claim 2, wherein in the normal direction, the minimum distance from the display device to the optical modulation element is greater than or equal to 10 centimeters and less than or equal to
$$\frac{1}{2} ( \frac{log \frac{300}{η \times B}}{log α} \times 100 - \frac{L}{\sqrt{2}} )$$
centimeters, where η is an optical efficiency of the optical modulation element, B is a center brightness of the display device, α is an optical distance maintenance rate of the display device, and L is a length of the optical modulation element.

4. The image display device as claimed in claim 2, wherein the display device is able to move along the normal direction, and a moving frequency of the display device is greater than 60 Hz.

5. The image display device as claimed in claim 2, wherein the moving device comprises an elastic material or a piezoelectric material.

6. The image display device as claimed in claim 2, wherein the modulation device further comprises a carrier and a supporting element, and the supporting element is connected between the moving device and the carrier.

7. The image display device as claimed in claim 2, wherein the modulation device further comprises a carrier and at least one transmission element, the at least one transmission element comprises a pulley and a transmission rope, and the moving device moves the carrier through the transmission rope.

8. The image display device as claimed in claim 1, wherein the modulation device comprises a lens module disposed between the display device and the optical modulation element.

9. The image display device as claimed in claim 1, wherein the modulation device comprises a polarizer, a liquid crystal panel, and a birefringent lens sequentially arranged on the display surface of the display panel.

10. The image display device as claimed in claim 1, wherein the optical modulation element has a plurality of openings, and sidewalls of each of the plurality of openings are mirror surfaces.

11. The image display device as claimed in claim 8, wherein the optical modulation element is a single-layer structure.

12. The image display device as claimed in claim 8, wherein the optical modulation element comprises a first reflective layer and a second reflective layer, the first reflective layer comprises a plurality of first reflective walls extending along a first direction, the second reflective layer comprises plurality of second reflective walls extending along a second direction, and the first reflective walls and the second reflective walls form the plurality of openings.

13. The image display device as claimed in claim 1, wherein the minimum distance from the first imaging position to the optical modulation element is the same as a minimum distance between the display surface and the optical modulation element when the display device is in the first state.

14. An image display device, comprising:
an optical modulation element;
a first display device having a display surface; and
a second display device, wherein the first display device and the second display device are disposed on a same side of the optical modulation element, an angle is between the optical modulation element and the display surface of the first display device, and the angle is greater than or equal to 20 degrees and less than or equal to 70 degrees,
wherein the first display device projects a first image at a first imaging position through the optical modulation element,
the second display device projects a second image at a second imaging position through the optical modulation element, and
a minimum distance from the first imaging position to the optical modulation element is different from a minimum distance from the second imaging position to the optical modulation element.

15. The image display device as claimed in claim 14, further comprising a beam splitting element disposed between the first display device and the optical modulation element.

16. The image display device as claimed in claim 15, wherein the first display device and the second display device are disposed on two side of the beam splitting element, respectively.

17. The image display device as claimed in claim 14, wherein the second display device is a transparent display device, and in a normal direction of the display surface, the second display device overlaps the first display device and the optical modulation element.

18. The image display device as claimed in claim 14, wherein the optical modulation element has a plurality of openings, and sidewalls of each of the plurality of openings are mirror surfaces.

19. The image display device as claimed in claim 18, wherein the optical modulation element is a single-layer structure.

20. The image display device as claimed in claim 18, wherein the optical modulation element comprises a first reflective layer and a second reflective layer, the first reflective layer comprises a plurality of first reflective walls extending along a first direction, the second reflective layer comprises a plurality of second reflective walls extending along a second direction, and the first reflective walls and the second reflective walls form the plurality of openings.
